(19) United States
(12) Patent Application Publication
(10) Pub. No.: US 2012/0185301 A1
(43) Pub. Date: Jul. 19, 2012

(54) PROCESS OPTIMIZATION SYSTEM

(75) Inventors: Raman V.K., Mumbai (IN); Ranjan Bandopadhyay, Mumbai (IN); Pankaj Agarwal, Mumbai (IN); Pawan Suri, Mumbai (IN); Viraj Saraiya, Mumbai (IN)

(73) Assignee: Tata Consultancy Services Limited, Mumbai (IN)

(21) Appl. No.: 13/348,040

(22) Filed: Jan. 11, 2012

(30) Foreign Application Priority Data
Jan. 14, 2011 (IN) 128/MUM/2011

(51) Int. Cl. G06Q 10/06

(52) U.S. Cl. 705/7.39

(57) ABSTRACT

Systems and methods for process optimization pertaining to Suppliers-Inputs-Process-Outputs-Customers (SIPOC) diagram for different processes optimization are described herein. In one implementation, a process optimization system is utilized for process optimization. The process optimization system comprises a processor, and a memory. The memory comprises a comparison module and an evaluation module. The evaluation module is configured to receive one or more evaluation parameters and evaluate a rating score for at least one attribute based at least in part on the one or more evaluation parameters. The comparison module is configured to determine one or more benchmark parameters based on the rating score, and provide one or more benchmark parameters.

### TECHNICAL FIELD

The present subject matter relates, in general, to process optimization and in particular, process optimization based on Suppliers-Inputs-Process-Outputs-Customers diagram, generally known as SIPOC.

### BACKGROUND

To continue to be competitive in the global marketplace, businesses can no longer simply rely on the best product being manufactured or the best process being implemented. Businesses typically aim at providing best products at less cost, by adopting business processes which can thrive in a highly competitive market. Competitiveness in a global market, in addition, require the business-makers to focus on a well built approach to process management, and a thorough understanding of the organization's processing capabilities, to meet future demands and value for a customer. Organizations aim at minimizing variability in manufacturing and business processes to improve the quality of outputs of the processes. Certain organizations utilize process management strategies aiming at improving business processes and creating new product or product designs by the best processes available.

Back in the days, for process optimization, organizations depended on manual expertise to implement process management strategies. Manual assistance was used to identify and remove any errors identified in the process.

Nowadays, to implement such business strategies, organizations utilize various systems implementing many established process and quality management tools, such as control charts, root cause analysis and histograms. One such tool utilized by organizations, analyzed manually for process management, is a Suppliers-Inputs-Process-Outputs-Customers (SIPOC) diagram. A SIPOC diagram lists elements like suppliers, inputs, etc., related to a process and aims at providing better understanding of elements associated with the process for its optimization.

SIPOC diagram is a tool which is effectively used in organizations allowing them to develop an understanding of business processes. To a person with required domain knowledge and process understanding, the SIPOC diagram helps in manually realizing defects inherent in the processes or in the selection of suppliers, inputs, outputs and customers related to the processes. Thus, a SIPOC diagram helps in manually identifying the selection of the relevant elements required for process optimization.

### SUMMARY

This summary is provided to introduce concepts related to process optimization system and method, which are further described below in the detailed description. This summary is not intended to identify essential features of the claimed subject matter nor is it intended for use in determining or limiting the scope of the claimed subject matter.

Method(s) and system(s) for process optimization pertaining to Suppliers-Inputs-Process-Outputs-Customers (SIPOC) diagram for different processes optimization are described. In one implementation, one or more evaluation parameters are received. Based on the evaluation parameters, a rating score is evaluated for each of plurality of attributes. Subsequent to the evaluation of rating score, one or more benchmark parameters are determined. These benchmarked parameters facilitate in optimization of other available SIPOCs of several different organizations.

### BRIEF DESCRIPTION OF THE DRAWINGS

The detailed description is provided with reference to the accompanying figures. In the figures, the left-most digit(s) of a reference number identifies the figure in which the reference number first appears. The same numbers are used throughout the drawings to reference like features and components.

FIG. 1 illustrates an exemplary computing environment implementing a process optimization system for evaluating and improving processes implemented by an organization, in accordance with an implementation of the present subject matter.

FIG. 2 illustrates components of an exemplary process optimization system, in accordance with an implementation of the present subject matter.

FIG. 3 illustrates an exemplary method of optimizing processes, in accordance with an implementation of the present subject matter.

### DETAILED DESCRIPTION

The present subject matter relates to process management strategies and more specifically to the process management tool Suppliers, Inputs, Process, Outputs, and Customers (SIPOC) diagram.

Conventionally, to develop a SIPOC diagram for a particular process, elements like outputs, customers, inputs, and suppliers of that process are determined The SIPOC diagram also facilitates clear identification of the elements related to the process and their influence on the process.

Organizations manually implement the SIPOC diagram for process optimization by considering suppliers (S) of the process, inputs (I) given by the suppliers for the process, outputs (O) that the process generates and customers (C) who receive the process outputs. Different organizations perform the same process in different ways and accordingly SIPOC diagram may vary from one organization to other even for the same business process.

Conventionally, to successfully develop a SIPOC diagram for process optimization, a process that needs to be optimized is identified. The process may contain different sub-processes which are listed under the same identified process. For example, for a process accounts payable, there can be several sub-processes like invoice processing, vendor maintenance, employee/voucher reimbursement, etc. For a particular process/sub-process in consideration, data for suppliers, inputs, outputs, and customers to complete the SIPOC diagram is collected. This data is referred to as attributes of the elements of the SIPOC diagram (referred to as a SIPOC hereinafter). SIPOC for a process is manually developed by listing the collected attributes under the different elements, i.e., the suppliers, inputs, outputs, and customers of that process.

The conventional methods of SIPOC development focuses on the manual techniques and steps followed in determining the outputs, customers, inputs, and suppliers, to optimize a process. As explained previously, each organisation implements its individual techniques for process implementation. Due to the independent implementation of processes at different organizations, the information inherited in different SIPOCs of different organizations is not effectively combined and used to optimize a particular process. The best practices of process implementation remain unknown to many organizations. These practices may yield better results, might implement the process in relatively-short duration of time or may perform the process more efficiently. Therefore, organizations need to perform process in better and efficient methods to achieve better productivity.

To this end, an automated process optimization system and method is described herein. The described system and method utilize the inherent information in the SIPOC of a process for optimization. The process optimization system optimizes processes by comparing them across different competitors and similar process adopting industries.

A SIPOC for a process can have 3 inputs required to start the process for producing a single output, wherein all the inputs required are supplied by a single supplier. In another implementation, there can be multiple suppliers for the inputs and the process may produce multiple outputs. Hence, the attribute entries under different elements in a SIPOC may vary as would be appreciated by a person skilled in the art.

The details can either be similar for many SIPOCs or may be different for different SIPOCs depending upon the methodology and process implementing techniques adopted by an organization. For example, in a process optimization for process X, an organization A may get the input from a supplier M while for the same process X, the supplier may be N for an organization B. At the same time, N may also be the supplier to another organization C for a process Y.

In addition, since different organizations implement similar processes in different ways, the SIPOCs developed for a single process across different organizations are different with different attributes for the various elements. The process optimization system accesses SIPOCs for different processes and from different organizations to collectively form a SIPOC repository. The process optimization system compares several SIPOCs developed for different organizations implementing the same process under consideration to offer an optimized solution. In one implementation, one SIPOC is selected as a benchmark SIPOC from among several SIPOCs based on factors, such as better productivity, less difficulty in implementation, low cost involved, etc. Benchmarking a SIPOC among several known SIPOCs provides an achievable standard to a process which requires improvement and optimization in any filed among suppliers, inputs, outputs, and customers. In said implementation, the process optimization system determines the attributes required for optimizing the process, with respect to the attributes of the benchmarked SIPOC and identifies the areas of improvement in the particular process.

In operation, the process optimization system accesses the SIPOCs from the SIPOC repository, implementing the process to be optimized developed for different organizations. Along with the data relevant to the SIPOC, data for other elements like productivity, accuracy, difficulty, etc., are also obtained from the SIPOC repository. The data entries for elements other than the standard elements such as suppliers, inputs, outputs, and customers are incorporated within SIPOC matrices to form a new SIPOC, referred to as E-SIPOC hereinafter. Also, the attributes listed under the elements of an E-SIPOC are referred to as E-SIPOC attributes hereinafter. Although, the E-SIPOC includes all the basic elements inherited by a SIPOC such as suppliers, inputs, process, outputs, and customers, it would be understood that an E-SIPOC can also be developed by fewer basic elements of SIPOC or with different combinations thereof. For example, an E-SIPOC may be developed by considering suppliers, inputs, process productivity, and accuracy, thereby not including the elements outputs and customers. In another example, an E-SIPOC may be developed by only considering the elements inputs, outputs and productivity for the Process.

From the available E-SIPOCs of different organizations, the process optimization system identifies a benchmark E-SIPOC based on factors, such as, better productivity, more accuracy, less difficulty, etc. The benchmark E-SIPOC acts as a reference E-SIPOC for the process optimization system to improve the implementation of similar process adopted by different organizations in different inefficient ways.

The process optimization system compares the attributes of elements like inputs, outputs, etc., related to a process to those of a benchmark E-SIPOC. With the help of comparisons based on pre-determined ratings associated with attributes of different elements, the process optimization system determines the attributes of every element like supplier, input, output, customers, applications used, etc., which need to be replaced by other attributes. The replacement is determined to achieve the standard of a benchmark E-SIPOC or of a SIPOC next in rank to the benchmark E-SIPOC. The process optimization system subsequently provides these changes in the attributes to a user. For example, an organization may be performing a process with attributes other than used in the benchmark E-SIPOC. The process optimization system would compare the attributes used by this organization with the attributes of the benchmark E-SIPOC to suggest changes, if required. Depending on the organizations E-SIPOC, the changes suggested can be limited to few attributes or can be for all attributes present in the E-SIPOC.

In one implementation, the process optimization system also provides solution independent of particular competitor process. To this end, the process optimization system determines benchmarks parameters. The benchmark parameters not only include benchmark E-SIPOC (as is already explained) but also include benchmark attribute for elements such as, input, supplier, etc. For optimization of an individual element, the process optimization module suggests the benchmarked attributes of that particular element.

System(s) implementing the disclosed method(s) include, but are not limited to, desktop computers, hand-held devices, multiprocessor systems, microprocessor based programmable consumer electronics, laptops, network computers, minicomputers, mainframe computers, and the like.

While aspects of described systems and methods of the process optimization system can be implemented in any number of different computing systems, environments, and/or configurations, the implementations are described in the context of the following exemplary system(s) and method(s).

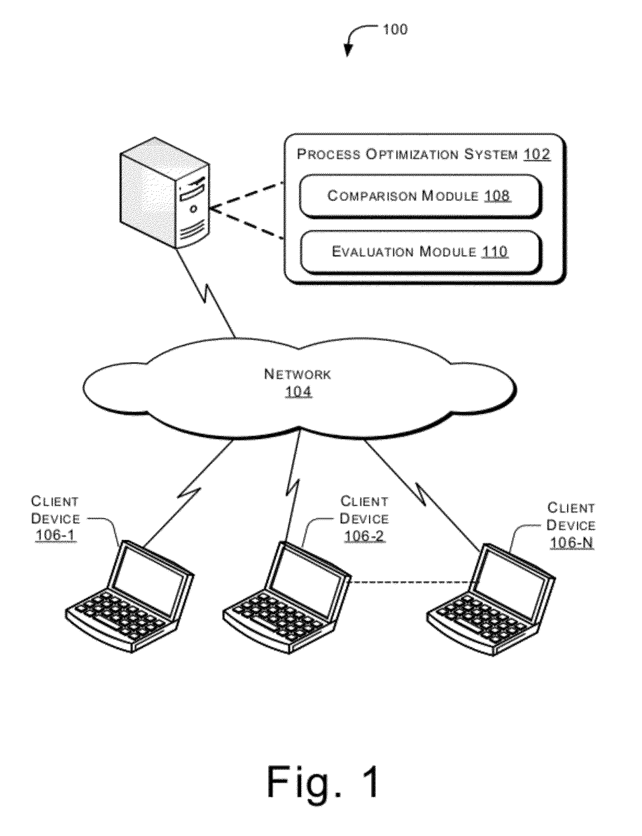

FIG. 1 shows an exemplary network environment 100 implementing a process optimization system 102 to compare and evaluate E-SIPOCs of various organizations, according to an implementation of the present subject matter. The process optimization system 102 is configured to enable comparison of E-SIPOC attributes and evaluation of available and generated data.

The network environment 100 includes the process optimization system 102 communicating through a network 104 with a plurality of client devices 106-1, 106-2 . . . 106-N, hereinafter collectively referred to as client device(s) 106.

The network 104 may be a wireless network, wired network or a combination thereof. The network 104 can be implemented as one of the different types of networks, such as intranet, local area network (LAN), wide area network (WAN), the internet, and such. The network 104 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other.

The client device(s) 106 are configured to feed the required data to the process optimization system 102. The client device(s) 106 are also configured to receive results from the process optimization system 102. These client device(s) 106 may be located at several remote locations of different organizations to store data of elements like suppliers, inputs, etc., associated with different processes. The client device(s) 106 may also be associated with the process optimization system for data entry or for use by a process optimization system administrator, also referred to as a system manager.

In one implementation, the process optimization system 102 includes a comparison module 108 and an evaluation module 110. The comparison module 108 is configured to examine different E-SIPOCs to determine the key differentiating factors between examined E-SIPOCs and identify best parameters referred to as benchmark parameters hereinafter. For example, the benchmark parameters that result in more productive and efficient process. In one implementation, the benchmark parameters include benchmark E-SIPOC and benchmark attributes. The comparison module 108 may also be configured to compare attributes of E-SIPOCs of different organizations to the benchmark parameters, such as, benchmark E-SIPOC and benchmark attributes.

Further, the evaluation module 110 performs certain evaluation functions and also is configured to ascertain different attributes of improvement based on the results of the comparison module 108. To this end, the evaluation module 110 is configured to evaluate the ratings related to every attribute and determine the scores associated with every SIPOC. In one implementation, the evaluation module 110 calculates the rating of every attribute related to a process based on certain key performance indicators (KPIs). In another implementation, the evaluation module is configured to evaluate rating score for E-SIPOCs.

The process optimization system 102 and the client devices 106 can be implemented as any of a variety of computing devices, including, for example, servers, desktop PCs, notebooks or portable computers, workstations, mainframe computers, mobile computing devices, entertainment devices, and an internet appliances. The process optimization system 102 can implement different process optimization processes such as a SIPOC comparison process and a process evaluation process.

For the purpose of process optimization, the process optimization system 102 collects the details of the suppliers, inputs, outputs and customers along with data of the elements like productivity, difficulty level, accuracy of the process, etc., for different organizations either through client device(s) 106 or from locally stored SIPOC repository, to produce E-SIPOCs of these organizations. Every new element introduced forms a new entry in a SIPOC. In one implementation, the data required to develop an E-SIPOC is introduced to the process optimization system 102 through different client device(s) 106. Different organizations can also supply entries for the elements of an E-SIPOC through client devices such as client device(s) 106 to be used by the process optimization system 102. In another implementation, the data can be supplied to the process optimization system 102 by an administrator from any of the on site located client devices such as client device(s) 106.

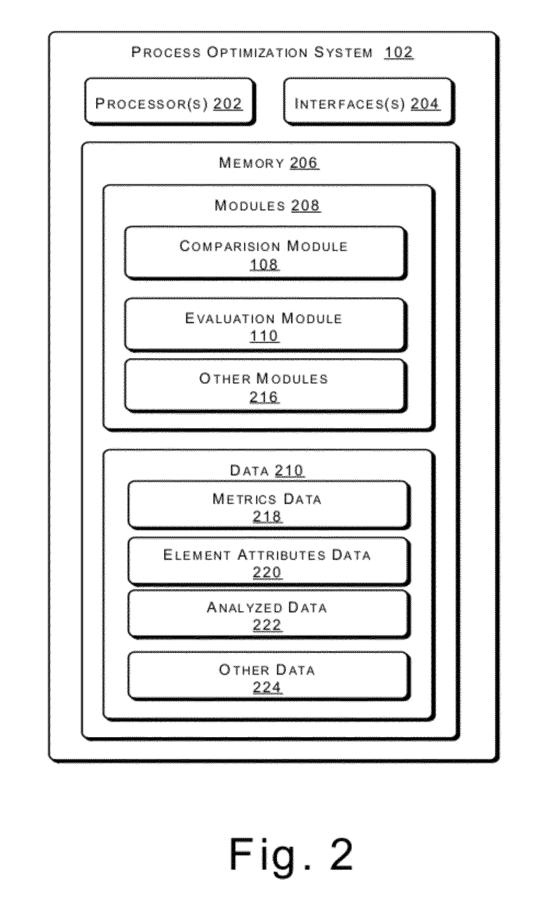

FIG. 2 shows an exemplary process optimization system 102 to compare and evaluate various E-SIPOCs, according to an implementation of the present subject matter. The process optimization system 102 includes processor(s) 202, interface(s) 204 and a memory 206. The processor(s) 202 can be a single processing unit or a number of units, all of which could include multiple computing units. The processor(s) 202 may be implemented as one or more microprocessor, microcomputers, digital signal processors, central processing units, state machines, logic circuitries, and/or any devices that manipulate signals based on operational instructions. Among other capabilities the processor(s) 202 are configured to fetch and execute computer-readable instructions stored in the memory.

The interface(s) 204 may include a variety of software and hardware interface, for example, interface for client device(s) 106 such as a desktop PC, a notebook or a portable computer, a workstation, etc. The peripheral devices connected through the interface(s) 204 data entry from one or more organizations. The devices would also facilitate the access to the process optimization system 102 for purposes such as viewing and modifying the documents.

The memory 206 may include any computer-readable medium known in the art including, for example volatile memory such as SRAMs and DRAMs and/or non-volatile memory such as EPROMs and flash memories. The memory 206 includes program module(s) 208 and data 210. The module(s) 208 include, for example, comparison module 108, evaluation module 110 and other module(s) 216. The other module(s) 216 include programs that supplement applications or functions performed by a process optimization system, such as process optimization system 102.

Additionally, the memory 206 further includes data 210 that serve, amongst other things, as repositories for storing data such as E-SIPOC matrices. The data 210 include, for example, metrics data 218, element attributes data 220, analyzed data 222 and other data 224. The module(s) 208, the data 210 and their operation are discussed in detail in the following explanation.

Organizations implementing a particular process for the first time require knowledge about ways of process implementation in terms of suppliers, inputs, process steps, outputs and customers. To this end, in one implementation, the process optimization system 102 implements the comparison module 108 to develop a standard SIPOC for the process. A standard SIPOC is a SIPOC that is developed by collating attribute entries of elements of several SIPOCs and generating a comprehensive list for suppliers, inputs, process steps, outputs and customers. Such developed SIPOC can act as a repository for new organizations interested in performing the said process. It provides an exhaustive list of attributes associated with each element of a SIPOC, thus providing choices of attributes to an organization that is new to the process implementation.

To develop the standard SIPOC, the comparison module 108 accesses all the SIPOCs of a particular process and compares each attribute entry of an element with every attribute listed under the same element of different SIPOCs accessed. A standard SIPOC is developed by listing all the same attributes under an element only once and listing the uncommon attributes under that element to the corresponding same element of the standard SIPOC. The attributes thus listed are stored in the element attributes data 220.

For example, say for a process Z, 2 SIPOCs A and B are available. Under the SIPOC element supplier, SIPOC A may have m attributes while SIPOC B may have n attributes. The comparison module 108 compares m attributes of SIPOC A with n attributes of SIPOC B to determine the common l attributes in both the SIPOC element suppliers. Hence the standard SIPOC created in this scenario includes m+n−l attributes under the element supplier. A similar approach is implemented by the process optimization system 102 to compare attributes under other elements like inputs, outputs, etc. to complete a standard SIPOC.

In one implementation, the process optimization system 102 is configured to compare different E-SIPOCs of different organizations to identify attributes that can be replaced to improve overall performance of the organization's process under consideration. The elements attribute data 220 contains all the possible attributes identified during the development of a standard SIPOC and thus contains an exhaustive list of attributes per element of a SIPOC known to process optimization system 102. In said embodiment, the metrics data 218 contains structured data of attributes of different SIPOCs involving different organizations and processes.

In one implementation, the process optimization system 102 obtains attribute data for one or more elements, to develop a plurality of E-SIPOCs for different organizations. The data of attributes of different SIPOCs available in the metrics 218 not only contains information for the standard elements such as suppliers, inputs, process, outputs and customers but also include information for additional elements such as productivity, accuracy, difficulty, impact, etc. The data entries for every element other than the standard element are incorporated within the SIPOC matrices to form the E-SIPOC. For example, the E-SIPOC may be understood as an extended SIPOC with added elements and added attributes associated with these elements.

In one implementation, the comparison module 108 is configured to facilitate an administrator to provide evaluation parameters, which may include E-SIPOC selection data that represents the E-SIPOC to be optimized and the process involved for which different E-SIPOCs are compared. The evaluation parameters may define the elements of an E-SIPOC to be optimized, elements to be considered for evaluation of rating scores of E-SIPOCs, etc. In said implementation, the evaluation parameters may also include information about key performance indicators (KPIs) to be utilized for the purpose of attribute rating.

The evaluation module 110 is configured to evaluate rating scores for the E-SIPOCs and their associated attributes based on one or more evaluation parameters received from a user, such as the KPIs to be used, elements of E-SIPOC to be considered, etc. The KPIs may include indicators such as reduction in cost, reduction in time, reduction in number of steps, etc., used to evaluate rating scores of attributes of an E-SIPOC. In another implementation, the evaluation parameters may also define the criteria for the evaluation of an E-SIPOC rating score by the evaluation module.

Although, the comparison of E-SIPOCs and their attributes has been explained to be based on the criteria received in the evaluation parameters, it would be understood that the process optimization system 102 may also identify a process, the elements and attributes to be compared and the KPIs to be used, on a pre-defined basis.

The evaluation module 110 is configured to evaluate rating scores for attributes of the E-SIPOCs based on one or more received evaluation parameters. Several evaluating algorithms and techniques can be implemented to quantify each attribute to be used by the process optimization system 102 based on the KPIs. In one implementation, the rating scores include ratings evaluated for the attributes associated with the E-SIPOCs. In another implementation, the rating scores may also include a total rating score evaluated for a complete E-SIPOC based on one or more evaluation parameters.

In one implementation, the rating of an attribute is based on one or more KPIs received in the evaluation parameters. A point is added to an attribute rating if it satisfies a key performance indicator. By default every attribute is given a rating of zero at the start of the evaluation process. For example, if an attribute is rated based on 3 KPI's such as reduction in cost, reduction in time and reduction in number of steps, the attribute would add one point to its rating if it reduces cost of the process over a predefined threshold incurred cost. The attribute would add another point to its rating if it also reduces time required to implement the process over a predefined conventional time, thereby making its overall rating to be 2. No point would be added to this attribute's rating if it does not reduce the number of steps in the process. Hence, the more KPIs an attribute qualifies, the more rating it gets. Therefore, by this evaluation process, every element of SIPOC has attributes with ratings associated to them when analyzed based on certain number of KPIs. However, in another implementation, the attributes can be provided with rating for every KPI on a relative scale of 10. For example, for an attribute to be evaluated against KPI reduction in cost, it can be provided a rating of 10 if the attribute is the most cost effective attribute known.

It would be appreciated by a person skilled in the art that the rating of an attribute might be done against several KPIs such as firstly against 7 KPIs and then against 4 KPIs and so on to develop metrics data 218 showing rating of different attributes based on number of KPIs considered. In one implementation, the evaluation thus done generates metrics data 218 of rating of all the attributes per element of E-SIPOC and saves it in the analyzed data 222 of memory 206. It must be noted that rating of every attribute is consistent in terms that for rating score calculation of an E-SIPOC or for comparisons between attributes, all ratings considered are the ones against same number of KPIs.

For example, to develop the score of an E-SIPOC X, the ratings of all the attributes may be the ratings evaluated against 4 KPIs. Similarly, for the same E-SIPOC, the score can be calculated by considering the rating of attributes evaluated against 7 KPIs. Hence, the KPIs used may vary depending upon the consideration but the consistency for the number of KPIs used and the corresponding rating considered is maintained. For the purpose of comparison, the scores for a benchmark E-SIPOC are also evaluated by the evaluation module 110.

The process optimization system 102 is configured to determine benchmark parameters. The benchmark parameters are determined on the basis of rating scores evaluated by the evaluation module 110. In one implementation, the benchmark parameters may include benchmark attributes. However, in another implementation the benchmark parameters may also include a benchmark E-SIPOC. One or more benchmark attributes are determined by the comparison module 108 after comparing the rating of E-SIPOC attributes.

Ratings of attributes listed under an element of several different E-SIPOCs under comparison are compared to determine a best known attribute referred to as benchmark attribute of the element. For example, optical character recognition (OCR) may be the benchmark attribute for the SIPOC element inputs i since the OCR input may have the best rating when compared to other attributes of element inputs like email, scanned copy, hard copy, etc. Hence, according to an implementation, the attribute with best rating in every element is marked as the benchmark attribute. Similarly, benchmark attributes for other elements are determined to constitute benchmark attributes for all elements.

To determine the benchmark E-SIPOC, the comparison module 108 compares all the E-SIPOCs of a chosen process based on received evaluation parameters. The evaluation parameters for benchmark E-SIPOC selection, may define the elements of an E-SIPOC to be considered, such as productivity, accuracy, number of outputs, difficulty level, impact, total rating score, etc. The comparison module 108 determines the organization implementing the process in the most efficient manner known to the process optimization system 102, when seen in light of certain evaluation parameters and thus benchmarks such organization's E-SIPOC for future reference. It must be noted that the use of a particular element to compare E-SIPOCs of organizations can either be determined by the evaluation parameters or can be fixed and pre-configured.

In an implementation, the comparison module 108 compares the E-SIPOCs available for the process chosen based on the pre-configured element productivity. The comparison module 108 compares the productivity of every organization and arranges the list of organizations in ascending or descending order of productivity. In another implementation, the comparison module 108 compares the E-SIPOCs available for the process chosen based on more than one element, such as productivity and accuracy.

For example, for a process x identified/received, there may be M number of organizations implementing the process and the data of every element of several different SIPOCs is stored in the data 210. The comparison module 108 accesses the E-SIPOC data and compares all M organizations based on pre-determined element productivity. An organization with the highest productivity is ranked first and an organization with the least productivity is ranked last. A list thus populated is arranged in ascending or descending order. This comparison arranges all the M organizations in order of their output productivity for the given process x. The E-SIPOC ranked first is identified as a benchmark E-SIPOC and can be used as reference for future comparison purposes.

In another implementation, multiple elements can be used to determine the benchmark E-SIPOC. The evaluation module 110 evaluates total rating of an E-SIPOC based on elements to be used in comparison by the process optimization system 102.

For example, a comparison is done by the comparison module 108 for a selected process Y. There are N numbers of organizations implementing the process. The data of E-SIPOCs are stored in the metrics data 218 and element attributes data 220. The evaluating module 110 fetches the E-SIPOC data and evaluates an output total rating for all N organizations based on the elements productivity and accuracy. A weightage of t % is assigned to productivity and w % is assigned to accuracy, where (t+w)=100 in this implementation. With the use of these weightages, the total ratings thus evaluated are used by the comparison module 108 to determine a benchmark E-SIPOC. The E-SIPOC of an organization with the highest total rating is ranked first and an E-SIPOC of an organization with the least total rating is ranked last. This comparison arranges all the E-SIPOCs of N organizations in order of their total rating for the given process Y, similar to the previous example.

In one implementation, the evaluation parameters may also include total rating score calculated on the basis of attribute ratings of an E-SIPOC for the evaluation of a benchmark E-SIPOC. The comparison is done on the basis of the total rating evaluated based on ratings of attributes. The ratings of attributes of all the elements associated with an E-SIPOC are used to evaluate the total rating of an E-SIPOC. In an example, for an E-SIPOC x, the rating of attributes under the element input is added to the rating of attributes under the elements suppliers, outputs and consumers to evaluate the total rating of the E-SIPOC x. This total rating thus computed can either be used alone or in combination with an element such as productivity to evaluate total rating score of the E-SIPOC. This total rating score can then be compared to evaluate a benchmark E-SIPOC.

Further, according to one implementation, the process optimization system 102 is configured to determine the attributes that have a scope of improvement for process optimization. An organization for which the process needs to be optimized is received by the process optimization system 102 in the evaluation parameters. The organization and the process for optimization thus selected are compared to the benchmarked parameters of that process.

The process optimization system 102 has rating scores of all the attributes known to the system. The method of rating evaluation has already been explained earlier. The comparison module 108 uses these ratings to identify the difference between presently used attribute in an E-SIPOC and the benchmarked attribute which can be used for that particular process.

To this end, the comparison module 108 compares the rating of attributes, listed under an element of the selected E-SIPOC to the benchmarked attributes of the same element. Since in one implementation where benchmark parameters include benchmark attributes, the attributes known to have highest rating were benchmarked, the rating of the attributes can either be less than or equal to the rating of the benchmark attributes. In case the rating of attributes of the selected E-SIPOC is equal to the rating of the benchmarked attributes, the process would not require any optimization. In such a scenario, the process optimization system 102 does not suggest any changes.

In case the rating of attributes is not equal to the rating of the benchmarked attributes, the comparison module 108 identifies a difference in the rating of compared attributes. The process optimization module 102 then provides the user with attributes of the same element having a greater rating than the rating of the attributes of the compared E-SIPOC. For example, let's say an attribute ‘a’ having a rating of 7 listed under element input of an E-SIPOC ‘x’ is compared to the benchmark attributes. The benchmark attribute of element input may have a rating of 9, which when compared to the attribute ‘a’ would not be equal. Hence, the process optimization system would provide the attributes of element input having rating 8 and 9. Similarly, the process optimization system 102 can provide attributes of one or more element like suppliers, customers, etc., to the user having rating greater than the rating of attributes of the selected E-SIPOC.

In another implementation, the comparison module 108 compares the total rating of an E-SIPOC in consideration to the total rating of the benchmark E-SIPOC. The total rating of the E-SIPOC in consideration can either be equal to or lesser than the benchmark total rating. A total rating more than the benchmark total rating is not possible as the benchmark E-SIPOC's total rating is the best possible total rating known to the system. In case the total rating of the E-SIPOC in consideration equals the benchmark total rating, the E-SIPOC is the benchmark E-SIPOC and has no scope of improvement as per the know attributes to the process optimization system 102. However a total rating less than the benchmark total rating shows that the E-SIPOC has areas of improvement and certain attributes have the scope of changes/modifications to optimize the process.

To this end, the comparison module 108 determines the E-SIPOCs having the total rating greater than that of the selected E-SIPOC and provides the attributes of such E-SIPOCs to the user. For instance, the comparison module 102 identifies 4 E-SIPOCs with greater total rating than that of the total rating of the selected E-SIPOC. The process optimization system 102 would provide these 4 E-SIPOCs of greater total rating score to the user along with attribute details associated with every provided E-SIPOC.

In one implementation, the process optimization system 102 also develops a hypothetical E-SIPOC based on the information, either collected from small and medium enterprises (SMEs) or other process implementing organizations. The E-SIPOCs formed with the data collected are included in the list of already available E-SIPOCs and the process of determining benchmark parameters is again performed, followed by the steps of attribute rating and their comparison as already discussed. Subsequently the attributes capable of improvement are identified for process optimization. Including E-SIPOCs made available by external organizations such as SMEs helps in providing attributes previously unknown to the process optimization system 102 and thus enabling better ways of process optimization.

It will be appreciated that the system and implementations described herein are provided for the purpose of example only and that none of the above mentioned implementations should be interpreted as necessarily requiring any of the disclosed functionality or steps nor should they be interpreted as necessarily excluding any functionality or steps.

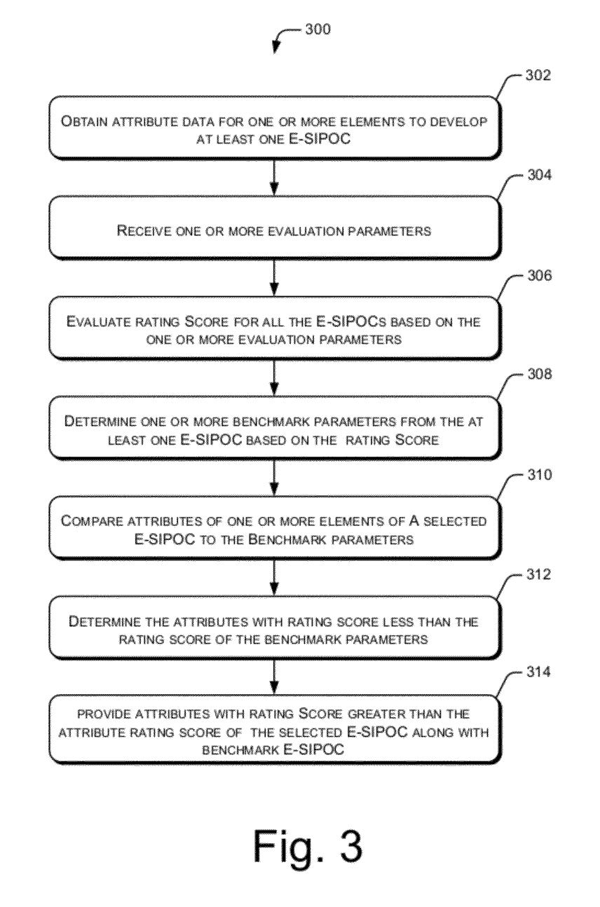

FIG. 3 illustrates an exemplary method 300 to implement a process optimization process, according to an implementation of the present subject matter.

The exemplary methods may be described in the general context of computer executable instructions. Generally, computer executable instructions can include routines, programs, objects, components, data structures, procedures, modules, functions, etc., that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices.

The order in which the methods are described is not intended to be construed as a limitation, and any number of the described method blocks can be combined in any order to implement the method, or an alternative method. Additionally, individual blocks may be deleted from the methods without departing from the spirit and scope of the subject matter described herein. Furthermore, the methods can be implemented in any suitable hardware, software, firmware, or combination thereof.

In accordance with one implementation of the present subject matter, the method 300 may be implemented in the previously described performance management system 100. However, it will be appreciated by one skilled in the art that such an implementation is not limiting. The method 300 may be implemented in a variety of performance evaluation and assessment system.

Referring to FIG. 3, at block 302, data of attributes for one or more elements of an E-SIPOC is obtained to develop at least one E-SIPOC. In one implementation, the data of attributes may include inputs required for the element input, suppliers linked to these inputs, output generated for the process and the customers using the output. In said implementation, the data for elements like productivity is also obtained to develop the E-SIPOCs. In one implementation, the data is obtained with the help of client devices, such as client device(s) 106. In another implementation, the data may be obtained from the SIPOC repository available to the process optimization system. The SIPOC repository may be located within the system or maybe installed at remote locations, configured to communicate with process optimization system 102 over some network such as the network 104.

At block 304, one or more evaluation parameters are received. In one implementation, the evaluation parameters include the key performance indicators (KPIs), elements to be used to evaluate rating score of different E-SIPOCs, a weightage assigned to the elements to help in determination of benchmark parameters, a selected E-SIPOC for process optimization, etc. In one implementation, the evaluation parameters are received from the user with the help of client devices, say client device(s) 106. In another implementation, the evaluation parameters are pre-configured values retrieved from a memory, say memory 206.

At block 306, rating score for all the E-SIPOCs are evaluated based on one or more received evaluation parameters. In one implementation, the rating score include the rating evaluated for the attributes of elements of E-SIPOCs based on received KPIs in evaluation parameters. In another implementation, the rating score include the total rating score of E-SIPOCs based on the weightage of elements received in the evaluation parameters. To this end, the evaluation module 110 evaluates the rating score for E-SIPOC attributes or for the E-SIPOCs itself, based on the received evaluation parameters. It would be appreciated that the rating score for the attributes and an E-SIPOC can be evaluated in different ways and by several different methods are previously explained. The rating scores thus generated, are stored in the analyzed data 222.

At block 308, one or more benchmark parameters are determined from the at least one E-SIPOC based on the evaluated rating scores. In one implementation, the benchmark parameters are determined by the comparison module 108 based on comparisons of evaluated rating scores. In one implementation, the benchmark parameters include benchmark attributes and benchmark E-SIPOC. The benchmark attributes may include attributes of one or more elements having best rating score among a particular element. For example, the benchmark attribute may contain optical character recognition (OCR) for the element input since the OCR input may have the best rating score when compared to other known attributes of element input like email, scanned copy, hard copy, etc. Hence, the attribute with best rating score in every element is marked as the benchmark attribute, together constituting benchmark attributes. The benchmark parameters can be stored in a memory, say memory 206.

In another implementation, the benchmark parameter includes a benchmark E-SIPOC determined based on the total rating of the E-SIPOC. In one implementation, an E-SIPOC is chosen as a benchmark E-SIPOC based on the rating score associated, evaluated after including rating score of attributes constituting the E-SIPOC. In another implementation, the benchmark E-SIPOC is determined based on a total rating generated after considering the weightages of elements like productivity, accuracy, difficulty, etc., received in the evaluation parameters.

At block 310, the attributes of one or more elements of a selected E-SIPOC are compared to the benchmark parameters. In one implementation, the selected E-SIPOC is received in the evaluation parameters at the block 304. The comparison module 108 compares the attributes of the selected E-SIPOC to the benchmarked parameters based on the rating scores evaluated at block 306. In one implementation, the attributes of the selected E-SIPOC are compared to the benchmarked attributes. In another implementation, the attributes of the selected E-SIPOC are compared to the attributes of the benchmark E-SIPOC.

At block 312, the comparison module 108 determines the attributes with rating score less than the rating score of benchmark parameters. In one implementation, the benchmark parameters include the benchmark attributes having the best rating score under one element. The attributes with rating score less than the rating score of the benchmark attributes are identified as the attributes which require improvement.

At block 314, one or more attributes with rating score between the rating score of attributes of the selected E-SIPOC and the rating score of the benchmark parameters are provided along with the benchmark E-SIPOC. In one implementation, the attributes are provided element wise based on benchmark attributes. For example, all the attributes having a rating score in between the rating score of attributes of the selected E-SIPOC and the benchmark attributes for an element are provided. Similarly, the attributes with greater rating score for the element suppliers can also be provided. However, in another implementation, the attributes are provided as complete E-SIPOCs. In such a scenario, the E-SIPOCs with total rating greater than the total rating of the selected E-SIPOC are provided.

Although implementations for process optimization has been described in language specific to structural features and/or methods, it is to be understood that the invention is not necessarily limited to the specific features or methods described. Rather, the specific features and methods for evaluating and managing the performance of an employee are disclosed as exemplary implementations of the present invention.

I/We claim:

1. A process optimization system comprising:
a processor; and
a memory coupled to the processor, wherein the memory comprises,
an evaluation module configured to,
receive one or more evaluation parameters; and
evaluate a rating score for at least one attribute based at least in part on the one or more evaluation parameters; and
a comparison module configured to determine one or more benchmark parameters based on the rating score.

2. The process optimization system as claimed in claim 1, wherein the evaluation module is configured to evaluate the rating score for at least one (E Suppliers-Inputs-Process-Outputs-Customers) E-SIPOC based on the one or more evaluation parameters.

3. The process optimization system as claimed in claim 1, wherein the one or more evaluation parameters include a plurality of key performance indicators (KPIs).

4. The process optimization system as claimed in claim 3, wherein the one or more evaluation parameters further include E-SIPOC selection data.

5. The process optimization system as claimed in claim 1, wherein the one or more benchmark parameters includes at least one benchmark E-SIPOC and at least one benchmark attribute.

6. The process optimization system as claimed in claim 1, wherein the comparison module is further configured to compare at least one rating score of an E-SIPOC with at least one rating score of the benchmark parameters.

7. The process optimization system as claimed in claim 6, wherein the comparison module is further configured to compare the rating score of at least one attribute of an element of an E-SIPOC with at least one rating score of the benchmark attribute of a corresponding element.

8. The process optimization system as claimed in claim 1, wherein the comparison module is further configured to provide one or more attributes based on one or more benchmark parameters.

9. The process optimization system as claimed in claim 1, wherein the evaluation module is further configured to evaluate a standard SIPOC.

10. A computer implemented method for process optimization, the method comprising:
receiving one or more evaluation parameters;
evaluating a rating score for at least a plurality of E-SIPOCs based on the one or more evaluation parameters;
determining at least one benchmark parameter based on the rating score; and
providing at least one attribute based on the at least one benchmark parameter.

11. The method as claimed in claim 10, wherein the method further comprises comparing the rating score for at least plurality of E-SIPOCs to determine the at least one benchmark parameter.

12. The method as claimed in claim 10, wherein the method further comprises comparing the rating score at least for plurality of attributes to determine the at least one benchmark parameter.

13. The method as claimed in claim 10, wherein the method further comprises selecting an E-SIPOC for optimization based on the one or more evaluation parameters.

14. A computer-readable medium having embodied thereon a computer program for executing a method comprising:
receiving one or more evaluation parameters;
evaluating a rating score for at least a plurality of E-SIPOCs based on the one or more evaluation parameters;
determining at least one benchmark parameter based on the rating score; and
providing at least one attribute based on the at least one benchmark parameter.
